(19) United States
(12) Patent Application Publication
(10) Pub. No.: US 2026/0280212 A1
(43) Pub. Date: Sep. 17, 2026

(54) ROTARY ELECTRICAL CONTACT ASSEMBLY

(71) Applicant: MERSEN ÖSTERREICH HITTISAU GES.M.B.H, Hittisau (AT)

(72) Inventors: Fabian SORGO, Au (AT); Fabian NEYER, Hittisau (AT); Wolfgang EBERLE, Sibratsgfäll (AT)

(73) Assignee: MERSEN ÖSTERREICH HITTISAU GES.M.B.H, Hittisau (AT)

(21) Appl. No.: 18/868,461

(22) PCT Filed: May 25, 2023
(86) PCT No.: PCT/IB2023/000325

§ 371 Date: Nov. 22, 2024

(30) Foreign Application Priority Data
May 25, 2022 (EP) 22175461.7

(51) Int. Cl. H01R 39/28

(52) U.S. Cl. CPC H01R 39/28

(57) ABSTRACT

A rolling electrical contact assembly for transferring current between rotatable parts, including a power transmission set having a first electrode and a second electrode, each having a ring-shaped angled electrically conductive contact surface of same first axis; at least one roller-holder assembly having one or a pair of rollers, each having a ring-shaped angled electrically conductive contact surface to roll onto the contact surfaces of the first and second electrodes while the first electrode is rotating, a shaft defining a second axis around to which is mounted each roller, at least one pressing device exerting force on each roller. The assembly includes one or two supporting members rotatably mounted around the first axis, wherein the second axis is radial to the first axis, and the contact surface of each roller protrudes from apertures in the supporting member(s) and the pressing device exerts force in the direction of the first axis.

### FIELD OF THE INVENTION

The present invention relates to connectors for establishing an electrical connection between two relatively rotatable members.

### BACKGROUND

Many applications require the transfer of electrical current to rotary parts, among which machine parts, wind turbines, offshore high voltage swivels or ship pods. Ship pods are propulsion and steering modules used to displace and direct a ship by means of a propeller which can rotate freely with respect to the ship and is driven by an electric motor. The electric current provided to the electric motor is generated inside the ship.

Different solutions are known for transferring electrical current to rotary parts.

A common solution is a rotary electrical conductor including slip rings and brushes, in which either the slip rings or the brushes rotate, and one or more sliding contacts are provided. However, in use, when there is no rotation for long periods and the position of brushes is fixed with respect to the slip rings, current always flows through the same points. This causes serious problems to the ring's surfaces (micro-craters and ghosting effect) and leads to a growing of contact resistance and increase of temperature (self-feeding phenomenon). Besides, on the ring parts normally not in contact with the brushes, can occur superficial coats due to oxidation phenomena, which may be facilitated by the environment, in particular a marine environment. When there is again a rotation, the brushes' operation is affected by the variation of contact surface roughness and contact resistance, and with time, brushes and rings deterioration occur.

Another solution is a rotary electrical conductor comprising roller bearings, but this solution suffers of the same drawbacks as the preceding one.

Another rotary electrical conductor includes coaxial rolling rings. Rings, arranged in pair, are rolling with respect to each other. However, it is difficult to obtain a correct alignment of the rings during assembly and the resulting electrical contact is not uniform since the concentricity of the rings is limited. In addition, only one ring per layer of transmission can be used, which implies a multiplication of layers if multiple transmissions are needed which increase the overall space requirement.

In another solution, mercury rotary joints are used. This system is well known since decades. Generally, such rotary conductor is used for low power applications (quite reduced dimension).

The main disadvantage is the use of a hazardous material, not compatible with marine or other outside applications.

In another solution, gears assembly is used. Gears allow transmitting motion and transferring power since, at any time, there is almost one tooth in contact with the corresponding part of a wheel. Planetary gears, with series of gears inserted in an external toothed crown, are often in used in industry.

In another recent solution, cone-shaped bodies rolling on rings are used. In this solution, cone-shaped bodies are encased between disks that rotate relative to each other. Such rotary electrical conductors are for example disclosed in the documents WO0201682A1, WO2021097502A1, and EP3195423B1.

WO0201682A1 discloses an electrical connector comprising two relatively rotatable members and a bearing assembly, the bearing assembly comprising bodies each defining a first substantially conical electrically conductive surface arranged in use to be in simultaneous non-sliding electrical contact with both of the members, the arrangement being such that each body rotates about its cone axis simultaneously with the relative rotation of the two members. The bodies are here arranged within a single piece ring-shaped housing rotatably mounted on the rotary shaft supporting the rotatable members. No more than two bodies can be arranged radially within the housing, allowing no more than two power transmissions. Since there is both no (or very low) friction and permanent contact, this solution overcomes the drawbacks of standard sliding contacts. In this electrical conductor, contact surfaces of the members are pressed against the contact surface of the at least one body by a spring force exerted in the direction of the rotation axis of the rotatable members. However, the manufacture must be carried out with very high precision to obtain line contacts formed between the contact surfaces, especially when a single body defines two distinct conductive surfaces. In practice, the formation of such line contacts can be disrupted by manufacturing tolerances and/or wear and tear over the course of operation.

To overcome this drawback, document WO2021097502A1 provides an electrical connector in which the angled contact surfaces of the rotatable members are free in the assembled state so that their angular positions can be changed relative to the angular positions of the support sections of the members. This is obtained by making the angled contact surfaces of the rotatable members in a thin metal sheet (maximal thickness of 2 mm). When the angled contact surfaces of the rotatable members are pressed against the angled contact surface of one rolling body by a spring force exerted in the direction of the rotation axis of the members, the pressure inclines the angled contact surfaces of the rotatable members such that they coincide with the angled contact surface of the rolling body in the assembled state. This allows ensuring the formation of a line contact between the contact surfaces. However, due to the low thickness of the angled contact surfaces of the rotatable members, this assembly cannot be used to transfer high electrical currents. In this electrical connector, the rolling bodies are also arranged in a ring-shaped housing the mounting of which is not detailed. This arrangement requires providing several layers of rollers/members if several power transmissions are needed.

EP3195423B1 provides a rotary conductor of similar structure with which high currents can be transferred in a stable and continuous manner. This document teaches to place the contact surfaces into rolling contact at high contact pressures to obtain a very stable and efficient transfer of electric current. The continuous rolling contact at high pressures allows having a fine mechanical “cold forming” effect (plastic deformation), causing a smoothening of the surfaces and an increase of the surface hardness. Such pressure is obtained by providing a spring element that biases the angled contact surface of each rolling body in the direction of the rotation axis of the rotatable members in the plane of the radial axis about which the rolling body rotates. However, as the rolling bodies are fixed to the central shaft around which rotate the rotatable member, when several transmissions are needed, several layers of rolling bodies are required which increases the size of the conductor in the direction of the shaft. Moreover, the assembly of each rolling body to the central shaft is quite complex. Also, the overall weight of the rotary conductor is quite high due to the structure of the members and the fixing of each rolling body to the central shaft. Such weight may induce a lack of stability during use.

There is therefore still a need for improved rotary electrical conductors of simple compact structure allowing high electrical current transfer.

### SUMMARY

The present invention relates to a rolling electrical contact assembly for transferring current between two relatively rotatable parts having a specific arrangement of the rollers.

### DETAILED DESCRIPTION

According to a first aspect, a rolling electrical contact assembly for transferring current between two relatively rotatable parts is proposed, such assembly comprising at least one power transmission set including:
a first electrode and a second electrode, each electrode comprising at least one ring-shaped angled electrically conductive contact surface, the contact surfaces of the electrodes having a same first axis and the first electrode being rotatably mounted around said first axis.

The rolling electrical contact assembly is characterized in that:
said at least one power transmission set comprises at least one roller-holder assembly comprising (i) one roller or a pair of rollers each comprising a ring-shaped angled electrically conductive contact surface conformed to roll onto the corresponding contact surfaces of the first and second electrodes while the first electrode is rotating around the first axis, (ii) a shaft defining a second axis around which is rotatably mounted the roller or the pair of rollers, (iii) at least one pressing device exerting a force F on said roller or pair of rollers along said shaft and (iv) mounting elements,
said rolling electrical contact assembly further comprises (i) a single supporting member, typically in the form of a plate, rotatably mounted around the first axis and having a thickness inferior to a minimal diameter of the contact surfaces of each roller or (ii) two supporting members, typically in the form of plates, rotatably mounted around the first axis and assembled to each other spaced along said first axis by a distance inferior to a minimal diameter of the contact surfaces of each roller, and
each roller-holder assembly of said at least one power transmission set is mounted (i) on the single supporting member or (ii) in between the two supporting members, in a position wherein the second axis defined by the shaft is radial to the first axis, the contact surface of the roller or pair of rollers protrudes from corresponding apertures provided in the supporting members and said at least one pressing device exerts a force F on said roller or pair of rollers in the direction of the first axis to push the roller contact surface of each roller onto said corresponding contact surfaces of the electrodes, the mounting elements of each roller-holder assembly cooperating with corresponding mounting elements provided in said supporting member(s).

By providing a roller-holder assembly, the invention allows pre-assembling the roller(s) and easier mounting/dismounting of the rollers in the rolling electrical contact assembly of the invention, thus improving the manufacturing process and reducing the maintenance operation durations. In particular, the contact pressure of a roller or pair of rollers within a roller-holder assembly can be tuned precisely and adapted to the transmission set. When several transmission sets are provided, it is thus possible to apply an appropriate contact pressure to each roller to allow rolling without slipping. In addition, the supporting member(s) along with the roller-holder assembly(ies) form a sub-assembly that can be easily mounted/dismounted in the rolling electrical contact assembly of the invention, improving further the manufacturing process and reducing the maintenance operation durations. The specific arrangement of the roller-holder assembly(ies) and the supporting member(s) also facilitate an accurate mounting of the roller(s) on the supporting member(s), resulting in an accurate mounting of the roller(s) with respect to the electrodes allowing reducing wear during operation.

As above mentioned, the single supporting member, typically in the form of a plate, has a thickness inferior to a minimal diameter of the contact surfaces of each roller, and once a roller-holder assembly is mounted on the single supporting member, the contact surface of each roller protrudes from both sides of the single supporting member.

Similarly, the two supporting members, typically in the form of plates, are assembled to each other spaced along said first axis by a distance inferior to a minimal diameter of the contact surfaces of each roller, and once a roller-holder assembly is mounted onto the two supporting members, the contact surface of each roller protrudes from both supporting members. In other words, the hole dimension of the assembled supporting members measured along the first axis is inferior to a minimal diameter of the contact surfaces of each roller.

In an embodiment, the mounting elements of the roller-holder assembly(ies) and of the supporting member(s) may be nesting elements allowing a very easy mounting without the need of tools. These nesting elements may be male and female nesting elements such as pins or rods or fingers or tabs or brackets cooperating with holes or recesses or grooves or slots, or any other similar cooperating male/female elements. This embodiment is particularly advantageous in the embodiment comprising two supporting members.

In another embodiment, the mounting elements of the roller-holder assembly(ies) and of the supporting plate(s) may include a pair of fixation tabs per roller-holder assembly, each fixation tab being fixed to a supporting member and receiving fixedly one end of the shaft of said roller-holder assembly. Advantageously, a pair of fixation tabs is fixed to a same face of a supporting member. The fixation tabs of all the roller-holder assemblies may be fixed on a same side of a supporting member or on opposite sides thereof. This embodiment is particularly advantageous in the embodiment comprising a single supporting member.

In the embodiment comprising two supporting members, the supporting members may be assembled to each other by means of spacers, easy to mount.

In the embodiment comprising two supporting members, the supporting members may be parallel supporting plates. The sub-assembly formed by the roller-holder assembly(ies) mounted on the supporting members is then formed in a simple fashion without increase of weight compared to solutions where the rollers are fixed directly to the first axis.

In combination with any of the previously described embodiments, each roller-holder assembly may comprise a housing receiving said roller or pair of rollers rotatably mounted around said shaft fixed to the housing, said housing having two opposite apertures through which protrudes the contact surface of said one roller or pair of rollers. These opposite apertures are thus open along the first axis. Such a housing may protect the roller and its rotating mounting on the shaft from dust and may also ease the mounting of said at least one pressing device.

In an embodiment, in combination or not with any of the previous embodiments, for smooth rotation, each roller, or pair of rollers, of a roller-holder assembly may be rotatably mounted around a shaft by means of a bearing. Such bearing may be selected among rolling element bearings, plain bearings and fluid bearings. Rolling element bearings contain rolling elements in the shape of balls, cylinders, needles or truncated cones. A preferred rolling element bearing is an angular ball bearing. In particular, such angular ball bearing may improve the rotational stability of the roller by accommodating combined loads applied to a roller, i.e. simultaneously acting radial and axial loads. Plain bearings also named “sliding contact bearings” or “sliding bearings” typically comprise a bearing surface and no rolling elements. Such a plain bearing may be integral with the roller or may be a bush inserted within the roller and having a bearing surface receiving the shaft of the roller. A preferred plain bearing includes a bush made of Teflon®. Plain bearings are inexpensive, compact and lightweight. Fluid bearings, such as hydrostatic bearings or hydrodynamic bearings, rely on pressurized gas or liquid to carry the load and eliminate friction. In fluid bearings, the stationary and rotating surfaces are separated by a thin film of lubricant, such as oil, air, water or process fluid. In a hydrodynamic fluid film bearing, the film pressure that separates the surfaces is created by the relative motion (rotation) of the surfaces as the lubricant is pulled into a converging geometry between the surfaces. In hydrostatic bearings, the fluid is externally pressurized by a pump. Fluid bearings may improve the contact between roller and the corresponding electrodes.

In an embodiment, in combination or not with any of the previous embodiments, said at least one roller-holder assembly may include pressure adjusting means cooperating with said at least one pressing device to adjust said force F. It is then possible to adjust the force F at a predetermined value which can be chosen to optimize the contact between the contact surfaces. Such force F is for example adjusted between 10 N and 200 N, preferably between 30 N and 60N, or between any of two of the preceding values. The pressure adjusting means may for example be conformed to adjust the length of an elastic means such as a spring, in particular a compression spring. The pressure adjusting means may for example include a nut screwed on a threaded part of the shaft.

In an embodiment, in combination or not with any of the previous embodiments, said at least one pressing device may comprise an elastic element mounted on said roller-holder assembly to exert the force F on said roller or pair of rollers of the roller-holder assembly. Such elastic element may be a compression spring, for example mounted around the shaft.

In an embodiment, in combination or not with any of the previous embodiments, for each roller of said at least one power transmission set, the contact surface of the roller and the corresponding contact surfaces of the electrodes may have a same angle αᵢ defined between said second axis and a contact line Lᵢ formed between the contact surface of the roller and the corresponding contact surfaces of the electrodes, and the value of αᵢ is equal to the value of the angle for which said contact line Lᵢ passes by an intersection point between said first and second axes.

Such a combination of the value of αᵢ and of a pressing device pushing the roller(s) radially in the direction of the first axis, provides a stable electrical contact with limited slipping and a reduced wear susceptibility of both roller(s) and electrodes allowing expanding maintenance intervals, and a decrease of electrical contact resistance for reducing electrical losses.

In an embodiment, in combination or not with any of the previous embodiments, for each roller, the value of a; may be equal or less than 45°, preferably equal or less than 35° or 25°, most preferably equal or less than 15°, typically between 5° and 20°. Such angles allow obtaining a compact assembly in the direction of the first axis.

In an embodiment, in combination or not with any of the previous embodiments, each contact surface may be formed on an external surface of a body, and optionally, said body is a ring-shaped body of an electrode or a wheel-shaped body of a roller. Such arrangements of the electrode body or of the roller body allows saving weight with respect to a body in the form of a disk. In a ring-shaped body or in a wheel-shaped body, the quantity of material can be limited to the strict necessary for making contact surfaces.

In particular, at least one contact surface chosen among a contact surface of a roller and the corresponding contact surface of an electrode, optionally both contact surfaces, may be plated or coated with a material having a conductivity higher than the conductivity of the material of their body. This allows reducing the overall cost of the body by using a high conductivity material only where it is necessary for obtaining an electrical transfer. The coated material or the plated material may be chosen among silver, gold and highly conductive copper alloys. By way of example, coating may be performed by electrolysis deposition or by projection of a melted allow, or by applying resin charged with conductive powder. Conductive metal plates may also be brazed on the surface.

In an embodiment, in combination or not with any of the previous embodiments, the rolling electrical contact assembly of the invention further may comprise conductive grease between the contact surface of a roller and the corresponding contact surface of an electrode. The use of lubricating grease allows decreasing the mechanical wear, improving the contact stability, while the conductivity of the grease allows limiting the electrical resistance between contact surfaces.

In an embodiment, in combination or not with any of the previous embodiments, each contact surface of a roller may have a roller mean diameter smaller than an electrode mean diameter of the corresponding contact surfaces of the electrodes, optionally a ratio of the roller mean diameter to the corresponding electrode mean diameter from 1:20 to 1:1, preferably from 1:8 to 1:4. Such arrangement allows providing a compact assembly in the direction of the first axis.

In an embodiment, in combination or not with any of the previous embodiments, each roller-holder assembly of said at least one power transmission set may comprise a pair of rollers, wherein each roller comprises a ring-shaped angled electrically conductive contact surface and the contact surfaces of both rollers roll onto the same corresponding contact surfaces of the first and second electrodes or onto two adjacent corresponding contact surfaces of the first and second electrodes, while the second electrode is rotating around the first axis. By providing two rolling contact surfaces for a same pair of first and second electrodes, higher currents can be transferred with reduced electrical losses with respect to a situation where a single contact surface of a roller is increased.

In an embodiment, in combination or not with any of the previous embodiments, the rolling electrical contact assembly of the invention may further comprise a first electrically isolating support and a second electrically isolating support, the first electrically isolating support being rotatably mounted with respect to the first axis, the first electrode of each power transmission set being mounted onto the first electrically isolating support and the second electrode of each power transmission set being mounted onto the second electrically isolating support, and optionally, said first and second electrically isolating support define a casing. Such arrangement provides a compact assembly easy to mount. The electrically isolating support may have a conical shape, the apex of which is directed towards the supporting members of the rollers or may preferably be parallel plates.

In an embodiment, in combination or not with any of the previous embodiments, the rolling electrical contact assembly of the invention may comprise two power transmission sets or more, wherein the first electrode, respectively the second electrode, of one power transmission set is arranged concentrically with respect to the first electrode, respectively the second electrode of the at least one other power transmission set, and the rollers of all the transmission sets have their second axis arranged in a same plane perpendicular to the first axis, and are mounted (i) onto the single supporting member or (ii) onto the two supporting members. Such arrangement allows making a rolling electrical contact assembly compact in the direction of the first axis allowing two or more distinct current and/or signal transmissions and with a reduced number of pieces as, for example, the first electrodes can be fixed to a same first electrically isolating support, the second electrodes can be fixed to a same second electrically isolating support.

When the rollers of different power transmission sets have very different dimensions (in particular different diameter) the electrically isolating support on which the electrodes are arranged concentrically may have a conical shape, the apex of which is directed towards the supporting members of the rollers or may be parallel plates (the dimensions of the bodies of the electrodes along the first axis may then vary). When the rollers of different power transmission sets have similar dimensions (in particular rollers of same or similar diameter) the electrically isolating support on which the electrodes are arranged concentrically may be parallel plates. In any embodiment, for reducing the weight as well as the overall height of the rolling electrical contact assembly of the invention, and also for easier manufacturing, the electrically isolating supports on which are mounted the electrodes may be parallel plates.

In an embodiment, in combination or not with any of the previous embodiments, the first electrodes of the two or more power transmission sets may be arranged concentrically on a same first electrically isolating support perpendicular to the first axis and the second electrodes of the two or more power transmission sets are arranged concentrically one a same second electrically isolating support perpendicular to the first axis.

In an embodiment, in combination or not with any of the previous embodiments, each power transmission set may further comprise at least a first electrical terminal electrically connected to the contact surface of the first electrode and at least a second electrical terminal electrically connected to the contact surface of the second electrode and the rolling electrical contact assembly may be suitable for leading currents from the first electrical terminal to the second electrical terminal of at least 700A, more preferably at least 1000A. For example, for copper electrodes, and a contact surface area of about 2 mm², currents of up to 700A via four rollers were measured at a contact pressure of 70-80 N/mm².

The maximal current allowed to go through one transmission set can be determined by calculation/experiments by the skilled man as a function of the area of the contact surface (depending on the number of rollers and the width the contact surfaces), the electrical resistance of the material of the contact surfaces, the contact resistance between the contact surfaces which depends from the pressure applied by the pressing device but also the materials used, the roughness of the contact surface, eventual grease present between the surfaces, . . . ).

The rolling electrical contact assembly according to the invention can be used in ship pods, wind turbines, offshore installations such as Floating Production Storage and Offloading vessels (FPSO's) or offshore floating structures (“floaters”) for wind turbine, or in machine parts, such as, but not limited to, a part of a welding machine or a part of a pyrolysis oven. The rotary conductors can also be used for transmitting electrical signals from one contact surface to the other at data rates of up to 1 Gb/s and higher.

According to a second aspect, a rotating system to be rotatably connected to an external power source is proposed, said rotating system comprising an electrical machine, characterized in that it further comprises a rolling electrical contact assembly according to the invention, wherein the second electrode of each power transmission set of said rolling electrical contact assembly is intended for being electrically connected to the external power source and the first electrode of each power transmission set of said rolling electrical contact assembly is electrically connected to the electrical machine.

According to a third aspect, in a first embodiment, a process for assembling a rolling electrical contact assembly, especially a rolling electrical contact assembly as disclosed above, is disclosed, such process comprising:
1) providing at least one power transmission set comprising a first electrode and a second electrode, each electrode comprising at least one ring-shaped angled electrically conductive contact surface, the contact surfaces of the electrodes having a same first axis and the first electrode being rotatably mounted around said first axis,
2) providing for each power transmission set at least one roller-holder assembly comprising (i) one roller or pair of rollers, each roller comprising a ring-shaped angled electrically conductive contact surface conformed to roll onto the corresponding contact surfaces of the first and second electrodes while the first electrode is rotating around the first axis, (ii) a shaft defining a second axis around which is rotatably mounted the roller or the pair of rollers, (iii) at least one pressing device exerting a force F on said roller or pair of rollers along said shaft and (iv) mounting elements,
3) providing a single supporting member, typically in the form of a plate, having a thickness inferior to a minimal diameter of the contact surfaces of each roller,
4) mounting said at least one roller-holder assembly onto the single supporting member by cooperation of the mounting elements of said at least one roller-holder assembly with corresponding mounting elements of the single supporting members, each roller-holder assembly being mounted on the single supporting member in a position wherein the second axis defined by the shaft is radial to the first axis, the contact surface of the roller or pair of rollers protrudes from corresponding apertures provided in the single supporting member and said at least one pressing device exerts a force F on said roller or pair of rollers in the direction of the first axis to push the roller contact surface of each roller onto said corresponding contact surfaces of the electrodes,
5) rotatably mounting the single supporting member around the first axis.

According to a third aspect, in a second embodiment, a process for assembling a rolling electrical contact assembly, especially a rolling electrical contact assembly as disclosed above, is disclosed, such process comprising:
1) providing at least one power transmission set comprising a first electrode and a second electrode, each electrode comprising at least one ring-shaped angled electrically conductive contact surface, the contact surfaces of the electrodes having a same first axis and the first electrode being rotatably mounted around said first axis,
2) providing for each power transmission set at least one roller-holder assembly comprising (i) one roller or pair of rollers, each roller comprising a ring-shaped angled electrically conductive contact surface conformed to roll onto the corresponding contact surfaces of the first and second electrodes while the first electrode is rotating around the first axis, (ii) a shaft defining a second axis around which is rotatably mounted the roller or the pair of rollers, (iii) at least one pressing device exerting a force F on said roller or pair of rollers along said shaft and (iv) mounting elements,
3) providing two supporting members, in particular two supporting plates,
4) mounting said at least one roller-holder assembly onto the supporting members by cooperation of the mounting elements of said at least one roller-holder assembly with corresponding mounting elements of the supporting members, each roller-holder assembly being mounted in between the two supporting members spaced along said first axis by a distance inferior to a minimal diameter of the contact surfaces of each roller, in a position wherein the second axis defined by the shaft is radial to the first axis, the contact surface of the roller or pair of rollers protrudes from corresponding apertures provided in the supporting members and said at least one pressing device exerts a force F on said roller or pair of rollers in the direction of the first axis to push the roller contact surface of each roller onto said corresponding contact surfaces of the electrodes,
5) assembling the two supporting members to each other, in particular the two supporting plates being parallel,
6) rotatably mounting the two supporting members, in particular the assembled supporting members, around the first axis.

In both embodiments, a very easy and rapid mounting of a rolling electrical contact assembly can then be obtained, allowing easy maintenance.

In any of the previous embodiments, the step of providing at least one roller-holder assembly may comprise:
(2a) molding and/or machining a roller body with a wheel shape,
(2b) providing a contact surface onto the roller body, for example by plating, to obtain a roller,
(2c) assembling a roller or a pair of rollers into a roller-holder assembly, by mounting said roller or pair of rollers onto the shaft and mounting the pressure device, and optionally mounting a pressure adjusting means,
(2d) optionally setting the pressure by adjusting the pressure adjusting means.

### DESCRIPTION OF THE DRAWINGS

The invention is illustrated by help of an example showing a potential embodiment of the invention.

FIG. 1 represents a perspective view of an embodiment of rolling electrical contact assembly in accordance with the present invention.

FIG. 2 is a cross-sectional view in perspective of the contact assembly of FIG. 1.

FIG. 3 is a cross-sectional view in perspective of an embodiment of a roller-supporting assembly.

FIG. 4 is a simplified section showing the contact surfaces between the electrodes and the rollers.

FIG. 5 is a perspective view of an embodiment of a second part of a casing receiving second electrodes.

FIG. 6 is a perspective view of an embodiment of a first part of a casing receiving first electrodes.

FIG. 7 is a perspective view of an embodiment of a roller-holder assembly to be mounted on two supporting members.

FIG. 8 is a perspective view of another embodiment of a roller-holder assembly mounted on a single mounting member represented partially in section.

In the following description, same references are used to design same or similar elements.

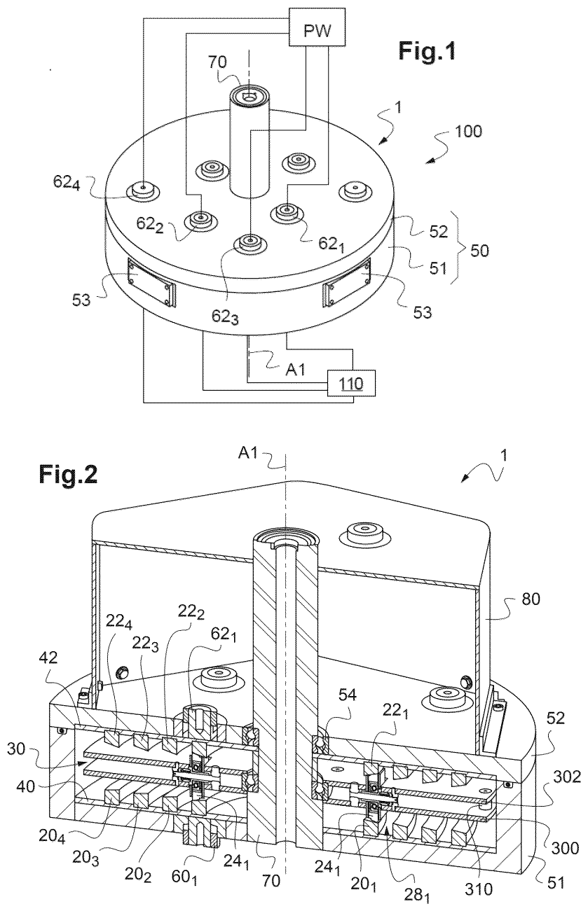

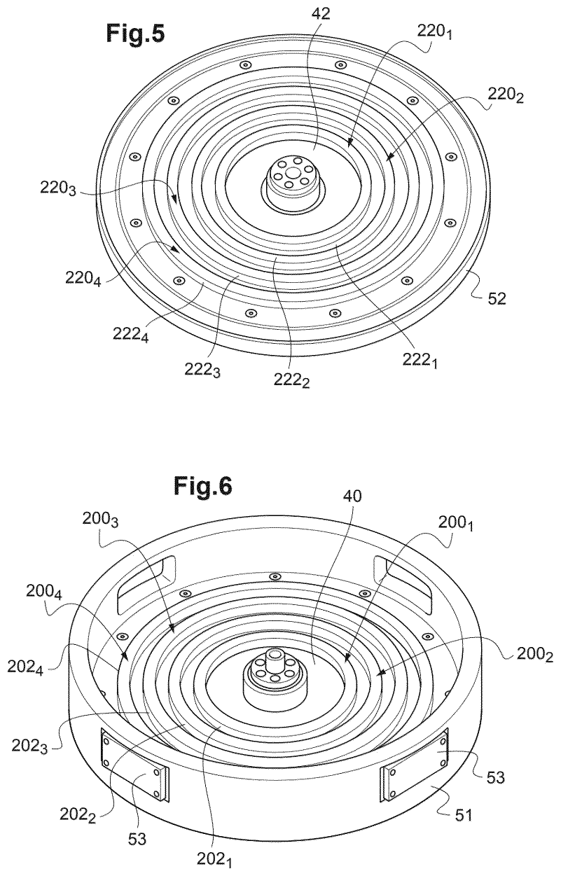

FIGS. 1-5 represent an embodiment of a rolling electrical contact assembly 1 comprising several power transmission sets, here four, noted 2ᵢ, with i=1, 2, 3, 4. In the following specification, “i” refers to the number of power transmission sets and a reference numeral noted 12ᵢ (with i=1, 2, 3 or 4 in the examples) denotes the element designated by reference 12 and belonging to the i^{th} power transmission set. The invention is however not limited to a particular number i of power transmission sets, and other rolling electrical contact assemblies with one, two, three, five, six or more power transmission sets may be envisaged. In other words, i is an integer not null, and preferably 1≤i≤8.

Each power transmission set 2ᵢ includes a first electrode 20ᵢ and a second electrode 22ᵢ, as well as at least one roller 24ᵢ. The first and second electrodes 20ᵢ, 22ᵢ are circular electrodes having a same central axis A1 when assembled. The second electrode 22ᵢ is a stationary electrode while the first electrode 20ᵢ is rotatably mounted around the central axis A1.

Each electrode 20ᵢ, 22ᵢ comprises at least one ring-shaped angled electrically conductive contact surface 200ᵢ, 220ᵢ, preferably a single ring-shaped angled contact surface, as represented on the drawings. The ring-shaped contact surfaces 200ᵢ, 220ᵢ of the electrodes have the same symmetry axis when assembled, which axis is also named “first axis” in the present invention and corresponds here to the central axis A1. In other words, the contact surfaces 200ᵢ, 220ᵢ are truncated cone-shaped surfaces.

Each roller 24ᵢ is mounted around a second axis A2 which is radial (perpendicular) to the first axis A1 and comprises a ring-shaped angled electrically conductive contact surface 240ᵢ conformed to roll onto the corresponding contact surfaces 200ᵢ, 220ᵢ of the first and second electrodes while the first electrode 20ᵢ is rotating around the first axis A1. In other words, a roller 24ᵢ rolls on two opposite tracks formed by the corresponding contact surfaces of the first and second electrodes of a power transmission set. In the present invention, contact surfaces are said to be corresponding when they belong to the same power transmission set. The contact surface 240ᵢ is thus also a truncated cone-shaped surface.

Finally, the power transmission set 2ᵢ comprises at least one pressing device 26ᵢ associated to at least one roller 24ᵢ, generally one or two, and exerting a force F along the second axis A2 in the direction of the first axis A1. This pressing device 26ᵢ is conformed to push the roller contact surface 240ᵢ of a roller onto the corresponding contact surfaces 200ᵢ, 220ᵢ of the electrodes. In the assembly 1 represented on the drawings, each power transmission set 2ᵢ has four rollers 24ᵢ. The invention is however not limited to a specific number of rollers per power transmission set 2ᵢ, the number of which may be different depending on the dimensions of the electrodes. Preferably, several rollers (two or more) are provided by power transmission set 2ᵢ which are advantageously arranged regularly around the first axis A1 to balance the overall weight.

As more clearly represented FIG. 4, for each roller 24ᵢ of a same power transmission set 2ᵢ, the contact surface 240ᵢ of the roller and the corresponding contact surfaces 200ᵢ, 220ᵢ of the electrodes have a same angle αᵢ defined between the second axis A2 and a contact line Lᵢ formed between the contact surface of the roller and the corresponding contact surfaces of the electrodes.

As represented FIG. 4, in a preferred embodiment, for each roller of a power transmission set 2ᵢ, the value of αᵢ is equal to the value of the angle for which said contact line Lᵢ passes by an intersection point O between the first and second axes A1, A2. This rule applies to all the power transmission sets.

In other words, the contact surfaces of the rollers 24ᵢ of a same power transmission set 2ᵢ, are angle shaped with the same value of angle αᵢ, while this angle value differs from one power transmission set to the other. Moreover, as can be seen on FIG. 4, for rollers of similar maximal radius belonging to different power transmission sets 21, the contact surfaces of the power transmission set 24 the farthest from the first axis A1 are angle shaped with an angle α4 smaller than the angles αᵢ of the contact surfaces of the next power transmission set in the direction of the first axis A1, and the power transmission set 21 the closest to the first axis has contact surfaces with the largest value of angle α1. Thus, α4<α3<α2<α1.

In other words, in this preferred embodiment, each roller contact surface 240ᵢ forms a truncated cone having a vertex angle equal to 2×αᵢ and its summit (apex) is the intersection point O between the axis of the truncated cone (second axis A2) and the first axis A1. This definition of angle αᵢ allows rolling of the rollers without slipping. For a proper stability operation, αᵢ should be preferably up to 45°, preferably up to 25°, and more preferably below 15°.

In another embodiment, the contact surfaces of the rollers 24ᵢ of all the power transmission sets 2ᵢ are angle shaped with the same value of angle αᵢ, as defined above. This implies that rollers from different power transmission sets 2ᵢ have different radii. The contact surfaces of the electrodes of the different power transmission sets 2ᵢ then follow a same imaginary conical form increasing the overall height. This implies to provide electrodes having bodies of different heights (measured along first axis) supported on a plate support perpendicular to the first axis, or to provide electrodes having bodies of the same height supported on a conical support.

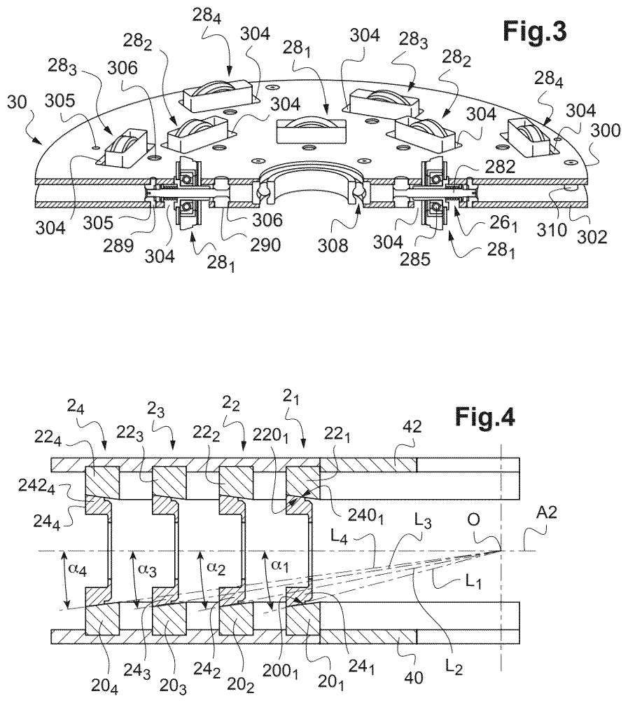

Whatever the embodiment, the corresponding angled contact surfaces 200ᵢ, 220ᵢ, 240ᵢ are generally each formed on an external surface of a body 202ᵢ, 222ᵢ, 242ᵢ, respectively, as represented on the drawings. Advantageously, as best seen on FIGS. 4-6, the first and second electrodes 20ᵢ, 22ᵢ have ring-shaped bodies 202ᵢ, 222ᵢ, and the rollers 24ᵢ have a wheel-shaped body 242ᵢ (see FIGS. 3, 4, 7-8). Both ring-shaped bodies 202ᵢ, 222ᵢ and wheel-shaped body 242ᵢ have a truncated conical external surface on which is formed the contact surfaces 200ᵢ, 220ᵢ, 240 ᵢ. These truncated conical external surfaces, more specifically the (truncated conical) contact surfaces formed thereon, each have a mean diameter which can be defined as the mean of its maximal diameter and its minimal diameter.

The ratio of a roller mean diameter to the corresponding electrode mean diameter may be from 1:20 to 1:1, preferably from 1:20 to 3:4, most preferably from 1:8 to 1:4 or within any of the previous limits.

By way of example, the following dimensions may be conceivable:
Electrode contact surface mean diameter between 100 mm and 640 mm, preferably between 200 mm and 400 mm,
Roller contact surface mean diameter between 10 mm and 100 mm.

Generally, the mean diameters of the contact surfaces of all the rollers are similar or identical in the rolling electrical contact assembly of the invention to limit the overall height. However, other configurations may be desirable.

The roller body 242ᵢ is generally made of metal, preferably copper or copper alloy (for mechanical properties it may contain zirconium or zinc for example). The roller body has typically a contact surface 240, which is plated or coated by a conductive metal having a higher conductivity than the metal of the body such as silver, gold and highly conductive copper alloys, preferably silver or copper alloys (containing about 1 to 3% of silver for example).

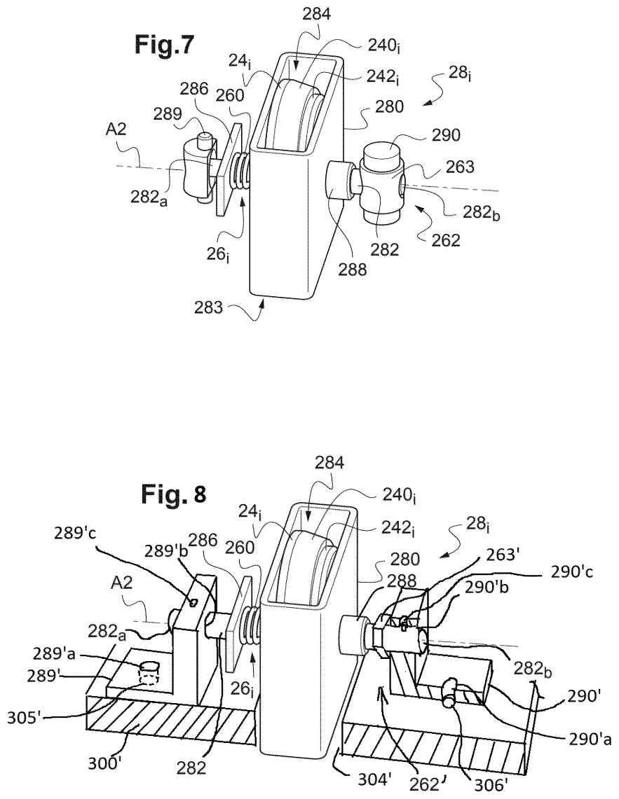

In the present invention, as represented on the drawings, each roller 24ᵢ is pre-mounted into a roller-holder assembly 28 ᵢ. As best seen on FIG. 7, in an embodiment, each roller-holder assembly 28ᵢ comprises a housing 280 receiving one roller 24ᵢ rotatably mounted around a shaft 282 fixed to the housing 280. This housing 280 has two opposite apertures 283, 284 through which protrudes the contact surface 240ᵢ of the roller 24_{i.}

As can be seen on FIG. 7, the housing 280 may be simply made of a tubular element of rectangular cross section in which is placed the roller 24ᵢ, more specifically the roller body 242ᵢ. The dimension of the housing 280 from one aperture 283 to the other 284 (i.e., the height of the tubular element along the first axis A1 when the housing is mounted into the assembly 1) is therefore smaller than the minimal radius of the contact surface 240ᵢ of the roller to avoid any interference of the housing with the corresponding contact surface of the first and second electrodes.

The roller 24ᵢ is mounted on the shaft 282 by means of a bearing 285, here an angular ball bearing 285, arranged to support a load exerted on the truncated conical external surface of the roller body. However, other rolling element bearings or other bearings such as plain bearings or fluid bearings are possible.

The pressure device 26ᵢ here comprises an elastic element 260 able to exert the force F on the roller or on the housing 280 of the roller-holder assembly 28ᵢ. The roller-holder assembly 28; also comprises in this embodiment pressure adjusting means 262 to adjust said force F.

In the present invention, as represented, the pressing device 28ᵢ is part of the roller-holder assembly 28 ᵢ. The elastic element 260 is here a compression spring arranged between one end 282a of the shaft 282 and the housing 280, and the adjusting means 262 includes a nut 263 screwed on a threaded part end part 282b of the shaft. More specifically, as represented, the shaft 282 crosses the housing 280 from one side to the other. On one side of the housing 280, the elastic element 260 is placed around the shaft 282 and abuts on one side against a stop plate 286 near a first extremity 282a of the shaft 282, and, on the other side, against the housing 280 or against the extremity of a sleeve 288 inserted within the housing 280 and receiving the shaft 282. On the opposite side of the housing 280, the extremity 282b of the shaft 282 has a threaded part on which is screwed nut 263. Thus, by screwing more or less the nut 263 on the threaded part of the shaft, it is possible to adjust the length of the elastic element 260 and therefore the force F exerted on the housing 280 and consequently along the roller along the second axis.

The housing 280 represented in FIG. 7 is dimensioned to receive a single roller body 242; mounted rotatably on the shaft 282. In another embodiment not represented, the housing 280 may be dimensioned to receive two roller bodies 242ᵢ rotatably mounted on the same shaft 282, for example separated by an elastic element such as an elastic washer. In such a case, the contact surfaces of both rollers cooperate with the same contact surfaces of the first and second electrodes or cooperate with adjacent contact surfaces of the first and second electrodes. In the last case, each of the first and second electrodes may therefore have two adjacent contact surfaces, distinct, but electrically connected.

The roller-holler assembly 28ᵢ further includes mounting elements adapted to be engaged on supporting members. These mounting elements here include two pins 289, 290 extending perpendicularly to the second axis of the roller. Such mounting elements are for example fixed to the shaft 282 supporting rotatably the roller (or a pair of rollers) at opposite ends thereof. In the embodiment represented, one 290 of the mounting elements forms the nut 263 of the pressure adjusting means.

It should be noted that the pressing device 28ᵢ is provided even if the housing 280 is omitted. In other words, the roller-holler assembly 28ᵢ may include the shaft 282 around which the roller 24ᵢ (or a pair of rollers) is rotatably mounted, preferably by means of the above-described bearing 285, and optionally the sleeve 288. Optionally, the roller-holler assembly 28ᵢ may further include the pressure adjusting means 262 and/or the housing 280.

It is worth to note that this roller-holder assembly 28ᵢ may be standardized, that is to say, a same housing can be usable for different sizes of roller bodies and different values of pressure. In addition, the pressure can be adjusted before the assembly of the roller-holder assembly into the rolling contact assembly.

By way of example, a force F between 30 and 60 N resulting into a contact pressure between 9 and 20 MPa can be obtained by using a roller having an external radius between 26 and 28 mm. If the radius of the roller is increased, the force would also need to be increased to ensure rolling without slipping. This could be simply done by means of the pressure adjusting means.

In the present invention, as represented on the drawings, each roller-holder assembly 28ᵢ is not mounted directly onto the first axis A1 but is supported by a rollers-supporting assembly 30, as seen on FIGS. 2 and 3. In the embodiment represented in these figures, this rollers-supporting assembly 30 comprises two supporting members 300, 302 rotatably mounted around the first axis A1 and assembled to each other spaced along the first axis by a distance inferior to a minimal diameter of the contact surfaces of each roller. Each roller-holder assembly 28ᵢ of all the power transmission sets 2ᵢ is engaged in between these supporting members 300, 302. For this purpose, each supporting member 300, 302 is provided with apertures 304, through which protrudes the contact surface 240ᵢ of each roller 24ᵢ so that this contact surface 240ᵢ can be in contact with the corresponding contact surfaces of the first and second electrodes. Thus, as represented on the figures, the whole dimension of the assembled supporting members 300, 302 measured along the first axis A1 is inferior to a minimal diameter of the contact surfaces of each roller and once a roller-holder assembly 28ᵢ is mounted onto the two supporting members, the contact surface of each roller protrudes from both supporting members.

In the embodiment represented, the supporting members 300, 302 are plates and in particular parallel supporting plates, here circular parallel supporting plates. The invention is however not limited to this particular form provided the supporting members can be assembled to each other spaced along the first axis by the above-mentioned distance.

The supporting members 300, 302 are typically made of an electrically insulated material (or a material covered or plated with an electrically insulating material), for example a polymer. These supporting members 300, 302, here in the form of discs, form a base support for all the rollers and are easy to adapt according to the number/size of rollers.

The mounting elements of the roller-holder assembly cooperates with corresponding mounting elements provided in the supporting members 300, 302. In the embodiment represented, the pins 289, 290 of each roller-holder assembly are nested within recesses 305, 306 provided in the supporting plates (see FIG. 3). The invention is not limited to such mounting elements. For example, the housing 280 (the edge thereof) may be directly engaged and nested within slots or grooves of the supporting members. In other words, the mounting elements may be formed within the housing 280 or may be a part thereof.

In another embodiment represented FIG. 8, a single supporting member 300′ may be used to support the roller-holder assemblies 28ᵢ. Such single supporting member 300′ is typically in the form of a plate having a thickness inferior to a minimal diameter of the contact surfaces of each roller, as represented partially FIG. 8. In the embodiment represented FIG. 8, the roller-holder assemblies 28ᵢ is similar to the one described in reference to the embodiment represented FIG. 7 and differs therefrom mainly by the mounting elements. Thus, in FIG. 8 the same components are designed by the same reference numerals and reference is made to the above description for more detail.

In the embodiment of FIG. 8, the mounting elements include a pair of fixation tabs 289′ and 290′ per roller-holder assembly 28ᵢ. Each fixation tab 289′, 290′ is fixed to the single supporting member 300′ and to the shaft 282 of the roller-holder assembly. In the example represented, each fixation tab has an “L” form. The invention is however not limited to a specific form of a fixation tab, provided that each tab can be fixed to the single supporting member 300′ and to one end of the shaft 282. In the example represented, each fixation tab comprises two apertures 289′a, 289′b ᵢ 290′a, 290′b: a first aperture 289′a, 290′a; a second aperture 289′b, 290′b for receiving the shaft 282. A third aperture 289′c, 290′c may be provided to introduce a pin or screw (not represented) to secure the shaft 282 to the fixation tab 289′, 290′. Alternatively, or in combination, one element selected among the shaft 282 and the single supporting member 300′ may be welded to the fixation tab.

Thus, as represented on the figure, once a roller-holder assembly 28ᵢ is mounted on the single supporting member, the contact surface of each roller protrudes from both sides of the single supporting member 300′.

As in the embodiment with two supporting members, the single supporting member 300′ is here provided with apertures 304′ through which protrudes the contact surface 240ᵢ of each roller 24ᵢ on both sides of the single supporting member 300′. Depending on the dimensions of the single supporting member 300′, the roller-holder assemblies 28ᵢ may be fixed to the single supporting member 300′ on a same side thereof or on both sides thereof.

As in the embodiment comprising two supporting members, each roller-holder assembly 28ᵢ may include or not the housing 280 and/or pressure adjusting means 262′ to adjust the force F. In this embodiment, a simple nut 263′ mounted on the threaded part of the extremity 282b of the shaft 282 may be used as pressure adjusting means 262′, this nut being here arranged between the fixation tab 290′ and the housing 280. In the example represented FIG. 8, the stop plate 286 is distinct from the fixation tab 289′. Alternatively, the stop plate 286 may be integral with the fixation tab 289′.

As already mentioned, the supporting members 300, 302, 300′ are rotatably mounted around the first axis A1, for example by means of a bearing 308, thus allowing the supporting members 300, 302, 300′ to rotate as the rollers rotate onto the electrodes. In the embodiment represented FIGS. 1-3 and 7, the supporting members 300, 302 are rotatably mounted onto a hub 70 of the rolling electrical contact assembly. This hub 70 thus defines the first axis A1. A similar mounting is possible for the single supporting member 300′ described in reference to FIG. 8.

The supporting members 300, 302 are assembled to each other, for example by means of spacers 310 placed extending between the supporting members to ensure they are spaced from each other from the above-mentioned distance and screwed or otherwise fixed to each supporting member. A rigid and resistant roller-supporting assembly 30 is then obtained. Similarly, a rigid and resistant roller-supporting assembly 30 is also obtained using a single supporting member 300′.

This roller-supporting assembly 30 is thus relatively easy to design and mount, since several roller-holder assemblies 28ᵢ can be located in free places onto, and partly between, the supporting members 300, 302, or 300′. As shown in the embodiment represented on the drawings, four power transmission sets 2ᵢ are provided, each set comprising four roller-holder assemblies 28_{i.}

The distance between the supporting members 300, 302 may allow an operator to proceed to maintenance on the roller-supporting assembly 30 (for example to add more grease on the contact surface of the rollers and/or to adjust the pressure of each roller-holder assembly), for example via the trap doors 53 described below. When a single supporting member 300′ is provided, such maintenance may be eased.

As represented more clearly on drawings 5 and 6, the rolling electrical contact assembly 1 further comprises a first electrically isolating support 40 on which is mounted the first electrode 20ᵢ of each power transmission set 2ᵢ and a second electrically isolating support 42 on which is mounted the second electrode 22ᵢ of each power transmission set 2ᵢ. The first electrically isolating support 40 is rotatably mounted with respect to the first axis A1. In the embodiment represented, the first and second electrically isolating supports 40, 42 are fixed, for example screwed, respectively to a first part 51 and a second part 52 of a casing 50. The first part 51 is thus rotatably mounted with respect to the first axis A1, and can rotate about this axis, while the second part 52 cannot rotate about the first axis A1.

Alternatively, the first and second electrically isolating support 40, 42 may define the casing 50. For example, the first electrically isolating support 40 and the first part 51 of the casing may be made of a first part without joining and assembly, and the second electrically isolating support 42 and the second part 52 of the casing may be made of a second part without joining and assembly.

In the embodiment represented, the casing 50 is provided with trap doors 53 to access the roller-supporting assembly 30.

The two parts 51, 52 of the casing 50 are assembled to close the casing while allowing the rotation of the first part 51 with respect to the second part 52. Preferably, the casing 50 is closed in a watertight manner, especially when used in a corrosive environment such as a marine environment, for example by using an appropriate seal junction between the two parts 51, 52.

In the embodiment represented, the first support 40 and the first part 51 of the casing are fixedly mounted onto the hub 70 which is a rotating piece around first axis A1, while the second support 42 and the second part 52 of the casing are fixed part, within which the hub 70 can rotate via a bearing 54. The invention is however not limited to this arrangement provided the first support 40 is rotating around first axis A1 and the second support 42 is a fixed part. A tightly closed housing 80 (see FIG. 2) may be fixed to the second part 52 of the casing to enclose the bearing 54 and partly an external surface of the second part 52 and the hub 70, as well as the electrical connectors 62ᵢ described below and their wiring.

As represented on the drawings, when two power transmission sets 2ᵢ or more are provided, the first and second electrodes 20ᵢ, 22ᵢ of one power transmission set 2ᵢ are arranged concentrically with respect to the first and second electrodes of the other power transmission sets 2ᵢ, here in a same plane perpendicular to the first axis A1. The space between the concentric electrodes will be sufficiently large to avoid any electrical contact between the electrodes. Optionally, an electrically isolating material may be provided between the ring-shaped electrodes. In the embodiment represented the first electrodes 20ᵢ are arranged concentrically on the first electrically isolating support 40 and the second electrodes 22ᵢ are arranged concentrically on the second electrically isolating support 42. Here both electrically isolating support 40, 42 are in the form of plates perpendicular to the first axis and thus parallel to each other which allows obtaining a compact configuration along the first axis. Other configurations (conical forms) may be envisaged as already explained.

With such concentric arrangement of the electrodes, the rollers 24ᵢ of all the transmission sets 2ᵢ have their second axis A2 arranged in a same plane perpendicular to the first axis A1. The rollers 24ᵢ of all the transmission sets 2ᵢ are thus engaged in between the two supporting members 300, 302.

Each power transmission set 2ᵢ further comprises a first electrical terminal or connector 60ᵢ electrically connected to the contact surface of the first electrode 20ᵢ and a second electrical terminal or connector 62ᵢ electrically connected to the contact surface of the second electrode 22ᵢ. More than one connector 60ᵢ, 62ᵢ by electrode 20ᵢ, 22ᵢ may be provided if high currents are transferred. In the embodiment represented, the connectors are provided through the electrically isolating supports 40, 42 and the casing 50. It should be noted that connectors 60ᵢ, 62ᵢ of all the power transmission sets 2ᵢ also have enough place due to the concentric arrangement of the electrodes.

The rolling electrical contact assembly 1 of the present invention is advantageously suitable for leading currents from the first electrical terminal to the second electrical terminal of at least 700A, more preferably at least 1000A.

If the current needs to be increased, several solutions are available, while keeping a certain compactness:
additional rollers may be added to a same power transmission set 2ᵢ (in the embodiment shown in the figures there are 4 rollers per power transmission set, but 2 or even 4 rollers could be provided);
increase the width of electrodes and arrange additional rollers in a same power transmission set; in this case the 2 rollers are mounted on a same shaft, with a flexible part in between to keep the pressure homogeneous; by enlarging the contact width between the rollers and electrodes, higher currents can be transmitted;
increase the contact width between the rollers and electrodes, by enlarging the width of both electrodes and rollers; the contact width may be enlarged up to a threshold value above which a limited contact may be obtained due to a surface default and/or a non-homogeneous pressure. Above such threshold value, two rollers rolling on a same pair of electrodes should be provided.

The two latter embodiments could also allow the rolling contact assembly to be used for higher speed (to enlarge the scope of applications), as the diameter of the electrodes will not increase too much.

To decrease the mechanical wear and improve the contact stability, a lubricating grease or oil is generally added between the contact surface of a roller and the corresponding contact surfaces of the first and second electrodes. This grease or oil may be chosen among conductive greases to limit the electrical resistance between contact surfaces (for example of the type of greases used for plug sets electrical connections). Such grease may be oil that is a non-conducting oil that comprises a suspension of conducting lubricating particles, preferably graphite particles. A suitable grease or lubricating oil is disclosed in EP3149812. Two exemplary brands of oil that can be successfully applied are high quality penetrating oils, based on graphite such as the oil marketed by Griffon under trade name EVIAL® or based on lithium such as the oil marketed by Klüber under trade name Synthesin PDL 250/01®.

The rolling electrical contact assembly 1 of the invention can be part of a rotating system 100 to be rotatably connected to an external power source PW. Such rotating system 100 comprises an electrical machine 110 and a rolling electrical contact assembly 1. The second electrode of each power transmission set of the rolling electrical contact assembly 1 can then be electrically connected to the external power source PW, for example via the connectors 62ᵢ, while the first electrode of each power transmission set of the rolling electrical contact assembly is electrically connected to the electrical machine 110 via the connectors 60ᵢ. The connections between the rolling electrical contact assembly 1, the external power source PW and the electrical machine 110 are schematically represented FIG. 1.

The assembly process of the rolling electrical contact assembly 1 of the invention may comprise (or include) the following steps:
1) providing at least one power transmission set 2ᵢ comprising a first electrode 20ᵢ and a second electrode 22ᵢ, each electrode comprising at least one ring-shaped angled electrically conductive contact surface 200ᵢ, 220ᵢ, the contact surfaces of the electrodes having a same first axis A1 and the first electrode 20ᵢ being rotatably mounted around said first axis, for example by assembling the first and second electrodes of each power transmission set 2ᵢ to the first and second electrically isolating supports 40, 42,
2) providing for each power transmission set 2ᵢ at least one roller-holder assembly 28; comprising (i) one roller 24ᵢ or pair of rollers 24ᵢ, each roller comprising a ring-shaped angled electrically conductive contact surface 240ᵢ conformed to roll onto the corresponding contact surfaces 200ᵢ, 220ᵢ of the first and second electrodes while the first electrode is rotating around the first axis, (ii) a shaft 282 defining a second axis A2 around which is rotatably mounted the roller 24ᵢ or the pair of rollers 24ᵢ, (iii) at least one pressing device 28ᵢ exerting a force F on said roller 24ᵢ or pair of rollers 24ᵢ along said shaft and (iv) mounting elements 289, 290, or 289′, 290′,
3) providing a single supporting member 300′ or two supporting members 300, 302, in particular each having apertures 304′, 304 respectively for the passage of each roller-holder assembly and mounting elements, 305′, 306′ and 305, 306 respectively conformed to cooperate with the mounting elements 289′, 290′; 289, 290 respectively of each roller-holder assembly,
4) mounting each roller-holder assembly 28ᵢ onto the single supporting member 300′ or onto the two supporting members 300, 302 by cooperation of the mounting elements (289′, 290′; 305′, 306′) (289, 290ᵢ 305, 306) respectively, with roller-holder assembly 28ᵢ mounted on the single supporting member 300′ or in between the two supporting members spaced along said first axis by the distance inferior to a minimal diameter of the contact surfaces of each roller, in a position wherein the second axis A2 defined by the shaft 282 is radial to the first axis A1, the contact surface of the roller or pair of rollers protrudes from the apertures 304′, 304 provided in the supporting members and the pressing device 26ᵢ exerts a force F on said roller 24ᵢ or pair of rollers 24ᵢ in the direction of the first axis to push the roller contact surface 240ᵢ of each roller onto the corresponding contact surfaces 200ᵢ, 220ᵢ of the electrodes,
5) assembling the supporting members to each other when two supporting members 300, 302 are provided, for example by means of the spacers 310 to obtain a roller-supporting assembly 30,
6) rotatably mounting the supporting member(s) around the first axis, for example by mounting the roller-supporting assembly 30 onto the hub 70.

In particular, step 1) may comprise (or include):
1a) assembling at least one first electrode 20ᵢ and at least one second electrode 22ᵢ onto the fist and second electrically isolating supports (40, 42) and connect the first and second electrodes to connectors 601, 62ᵢ, said supports constituting, or being fixed within, a casing 50 when the rolling contact assembly is completely mounted,
1b) mounting the electrically isolating supports 40, 42 onto the hub 70 with the roller-supporting assembly 30 in between, the support 42 being fixedly mounted to the hub 70, while the support 40 is rotatably mounted onto the hub 70.

Such assembling can be performed rapidly and simply.

The step 2) of providing at least one roller-holder assembly 28ᵢ may comprise (or include):
2a) molding and/or machining a roller body 242ᵢ with a wheel shape,
2b) providing a contact surface 240ᵢ onto the roller body 242ᵢ, for example by plating or by coating, to obtain a roller 24ᵢ,
2c) assembling a roller 24ᵢ or a pair of rollers 24ᵢ into a roller-holder assembly 28ᵢ, by mounting said roller or pair of rollers onto a shaft 282, and mounting the pressure device 28ᵢ for example comprising an elastic element 260, and optionally a pressure adjusting means 262, 262′, and optionally mounting the roller(s) within a housing 280,
2d) optionally setting the pressure by adjusting the pressure adjusting means 262, 262′, for example by tightening of the nut 263, 263′ and screw part of the shaft 282 supporting the roller or the pair of rollers.

Such roller-holder assembly can therefore be easily prepared before its mounting into the rolling electrical contact assembly of the invention.

1. A rolling electrical contact assembly for transferring current between two relatively rotatable parts, comprising at least one power transmission set including:
a first electrode and a second electrode each electrode comprising at least one ring-shaped angled electrically conductive contact surface, the contact surfaces of the electrodes having a same first axis and the first electrode being rotatably mounted around said first axis,
wherein,
said at least one power transmission set comprises at least one roller-holder assembly comprising one roller or a pair of rollers each comprising a ring-shaped angled electrically conductive contact surface conformed to roll onto the corresponding contact surfaces of the first and second electrodes while the first electrode is rotating around the first axis, a shaft defining a second axis around which is rotatably mounted the roller or the pair of rollers at least one pressing device exerting a force F on said roller or pair of rollers along said shaft and mounting elements,
said rolling electrical contact assembly further comprises a single supporting plate rotatably mounted around the first axis and having a thickness inferior to a minimal diameter of the contact surfaces of each roller or two parallel supporting plates rotatably mounted around the first axis and assembled to each other spaced along said first axis by a distance inferior to a minimal diameter of the contact surfaces of each roller, and
each roller-holder assembly of said at least one power transmission set is mounted on the single supporting plate or in between the two parallel supporting plates, in a position wherein the second axis defined by the shaft is radial to the first axis, the contact surface of the roller or pair of rollers protrudes from corresponding apertures provided in said supporting plate(s) and said at least one pressing device exerts a force F on said roller or pair of rollers in the direction of the first axis to push the roller contact surface of each roller onto said corresponding contact surfaces of the electrodes, the mounting elements of each roller-holder assembly cooperating with corresponding mounting elements provided in said supporting plate(s).

2. The rolling electrical contact assembly according to claim 1, wherein each roller-holder assembly comprises a housing receiving said roller or pair of rollers rotatably mounted around said shaft fixed to the housing, said housing having two opposite apertures through which protrudes the contact surface of said one roller or pair of rollers.

3. The rolling electrical contact assembly according to claim 1, characterized in that each roller or pair of rollers of a roller-holder assembly is rotatably mounted around a shaft by means of a bearing.

4. The rolling electrical contact assembly according to claim 1, wherein said at least one roller-holder assembly includes pressure adjusting means cooperating with said at least one pressing device to adjust said force F.

5. The rolling electrical contact assembly according to claim 1, wherein said at least one pressing device comprises an elastic element mounted on said roller-holder assembly to exert the force F on said roller or pair of rollers.

6. The rolling electrical contact assembly according to claim 1, wherein, for each roller of said at least one power transmission set, the contact surface of the roller and the corresponding contact surfaces of the electrodes have a same angle αᵢ defined between said second axis and a contact line Lᵢ formed between the contact surface of the roller and the corresponding contact surfaces of the electrodes, and the value of αᵢ is equal to the value of the angle for which said contact line Lᵢ passes by an intersection point between said first and second axes, optionally, for each roller, the value of αᵢ is equal or less than 45°.

7. The rolling electrical contact assembly according to any one claim 1, wherein each contact surface is formed on an external surface of a body, and optionally, said body is a ring-shaped body of an electrode or a wheel-shaped body of a roller.

8. The rolling electrical contact assembly according to claim 7, wherein at least one contact surface chosen among a contact surface of a roller and the corresponding contact surface of an electrode, is coated or plated with a material having a conductivity higher than the conductivity of the material of their body.

9. The rolling electrical contact assembly according to claim 1, wherein, each contact surface of a roller has a roller mean diameter smaller than an electrode mean diameter of the corresponding contact surfaces of the electrodes, optionally a ratio of the roller mean diameter to the corresponding electrode mean diameter is from 1:20 to 1:1, preferably from 1:8 to 1:4.

10. The rolling electrical contact assembly according to claim 1, wherein each roller-holder assembly of said at least one power transmission set comprises a pair of rollers wherein each roller comprises a ring-shaped angled electrically conductive contact surface and the contact surfaces of both rollers roll onto the same corresponding contact surfaces of the first and second electrodes or onto two adjacent corresponding contact surfaces of the first and second electrodes, while the second electrode is rotating around the first axis.

11. The rolling electrical contact assembly according to claim 1, further comprising a first electrically isolating support and a second electrically isolating support, the first electrically isolating support being rotatably mounted with respect to the first axis, the first electrode of each power transmission set being mounted onto the first electrically isolating support and the second electrode of each power transmission set being mounted onto the second electrically isolating support and optionally, said first and second electrically isolating supports define a casing.

12. The rolling electrical contact assembly according to claim 1, comprising two power transmission sets or more, wherein the first electrode, respectively the second electrode, of one power transmission set is arranged concentrically with respect to the first electrode, respectively the second electrode, of the at least one other power transmission set, and the rollers of all the transmission sets have their second axis arranged in a same plane perpendicular to the first axis and are mounted onto the single supporting plate or onto the two supporting plates.

13. The rolling electrical contact assembly according to claim 12, wherein the first electrodes of the two or more power transmission sets are arranged concentrically on a same first electrically isolating support perpendicular to the first axis and the second electrodes of the two or more power transmission sets are arranged concentrically on a same second electrically isolating support perpendicular to the first axis.

14. The rolling electrical contact assembly according to claim 1, wherein, each power transmission set further comprises at least a first electrical terminal electrically connected to the contact surface of the first electrode and at least a second electrical terminal electrically connected to the contact surface of the second electrode and wherein the rolling electrical contact assembly is suitable for leading currents from the first electrical terminal to the second electrical terminal of at least 700A, more preferably at least 1000A.

15. A rotating system to be rotatably connected to an external power source, said rotating system comprising an electrical machine, and a rolling electrical contact assembly according to claim 1, wherein the second electrode of each power transmission set of said rolling electrical contact assembly is intended for being electrically connected to the external power source and the first electrode of each power transmission set of said rolling electrical contact assembly is electrically connected to the electrical machine.

16. A process for assembling a rolling electrical contact assembly, comprising:
1) providing at least one power transmission set comprising a first electrode and a second electrode, each electrode comprising at least one ring-shaped angled electrically conductive contact surface, the contact surfaces of the electrodes having a same first axis and the first electrode being rotatably mounted around said first axis,
2) providing for each power transmission set at least one roller-holder assembly comprising one roller or pair of rollers, each roller comprising a ring-shaped angled electrically conductive contact surface conformed to roll onto the corresponding contact surfaces of the first and second electrodes while the first electrode is rotating around the first axis, a shaft defining a second axis around which is rotatably mounted the roller or the pair of rollers at least one pressing device exerting a force F on said roller or pair of rollers along said shaft and mounting elements,
3) providing a single supporting plate having a thickness inferior to a minimal diameter of the contact surfaces of each roller or two supporting plates
4) mounting said at least one roller-holder assembly onto the single supporting plate onto the two supporting plates by cooperation of the mounting elements of said at least one roller-holder assembly with corresponding mounting elements of the supporting plate(s), each roller-holder assembly being mounted on the single supporting plate or in between the two supporting plates spaced along said first axis by a distance inferior to a minimal diameter of the contact surfaces of each roller, in a position wherein the second axis defined by the shaft is radial to the first axis the contact surface of the roller or pair of rollers protrudes from corresponding apertures provided in the single supporting plate or in the two supporting plates and said at least one pressing device exerts a force F on said roller or pair of rollers in the direction of the first axis to push the roller contact surface of each roller onto said corresponding contact surfaces of the electrodes,
5) assembling the two supporting plates to each other when two supporting plates are provided, those two supporting plates being parallel,
6) rotatably mounting the single supporting plate or the two supporting plates around the first axis.

17. The process for assembling a rolling electrical contact assembly according to claim 16, wherein the step of providing at least one roller-holder assembly comprises:
molding and/or machining a roller body with a wheel shape,
providing a contact surface onto the roller body, for example by plating, to obtain a roller,
assembling a roller or a pair of rollers into a roller-holder assembly, by mounting said roller or pair of rollers onto the shaft and mounting the pressure device, and optionally mounting a pressure adjusting means,
optionally setting the pressure by adjusting the pressure adjusting means.
